(19) United States
(12) Patent Application Publication
(10) Pub. No.: US 2022/0204676 A1
(43) Pub. Date: Jun. 30, 2022

(54) COPOLYMER AND BLEND

(71) Applicant: INDUSTRIAL TECHNOLOGY RESEARCH INSTITUTE, Hsinchu (TW)

(72) Inventors: Ping-Yen CHEN, Taichung City (TW); Pei-Yin CHEN, Taipei City (TW); Yen-Cheng LI, Hsinchu City (TW)

(73) Assignee: INDUSTRIAL TECHNOLOGY RESEARCH INSTITUTE, Hsinchu (TW)

(21) Appl. No.: 17/135,294

(22) Filed: Dec. 28, 2020

(51) Int. Cl. C08F 283/00; C08L 81/04

(52) U.S. Cl. CPC C08F 283/00; C08L 81/04

(57) ABSTRACT

A copolymer includes a repeating unit corresponding to polyether sulfone and a repeating unit corresponding to vinyl monomer. The repeating unit corresponding to polyether sulfone has a repeating number of 200 to 450, and the repeating unit corresponding to vinyl monomer has a repeating number of 20 to 100. The copolymer can be blended with another polymer such as polyphenylene sulfide to form a blend.

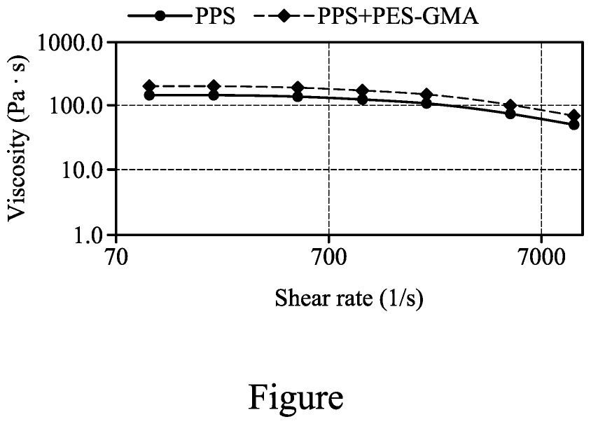

### TECHNICAL FIELD

The technical field relates to a copolymer containing a repeating unit corresponding to polyether sulfone and a repeating unit corresponding to vinyl monomer, and in particular it relates to a blend of polyphenylene sulfide and the copolymer.

### BACKGROUND

Polymer composite, polymer alloy, and polymer gel may combine different types of polymer materials to improve the physical properties of a single polymer. The aromatic polyether sulfone is an amorphous engineering plastic with excellent chemical resistance, thermal stability, and mechanical strength, which is suitable to formulate polymer composite, polymer alloy, and polymer gel to improve their chemical resistance, thermal resistance, toughness, and the like.

However, the aromatic polyether sulfone cannot be evenly blended and dispersed with general plastics due to its aromatic structure and polarity difference. Compatibilizer should be added to enhance dispersity and to improve performance. However, the compatibilizer may degrade some of the properties of the blend. Accordingly, a modified polyether sulfone resin is called for to serve as a modifier of another polymer without adding compatibilizer.

### SUMMARY

One embodiment of the disclosure provides a copolymer, including: a repeating unit corresponding to polyether sulfone and a repeating unit corresponding to vinyl monomer, wherein the repeating unit corresponding to polyether sulfone has a repeating number of 200 to 450, and the repeating unit corresponding to vinyl monomer has a repeating number of 20 to 100.

In some embodiments, the vinyl monomer is

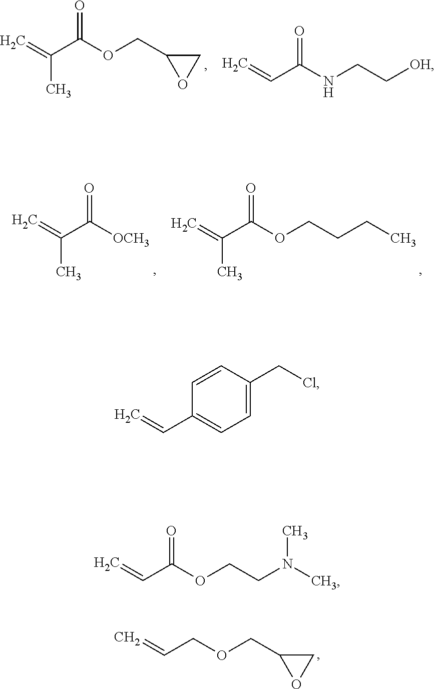

or a combination thereof.

In some embodiments, the repeating unit corresponding to polyether sulfone is

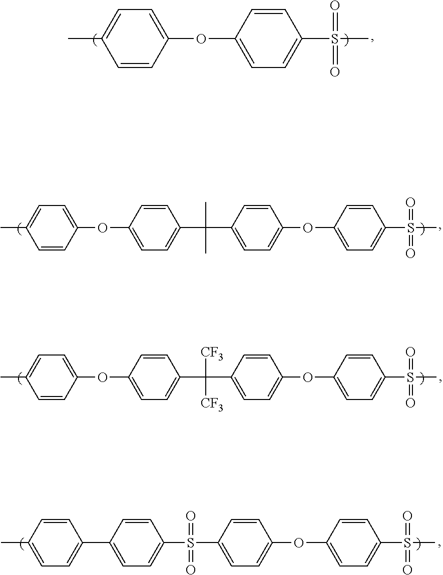

or a combination thereof.

One embodiment of the disclosure provides a blend, including: polyphenylene sulfide and a copolymer blended to each other, wherein the polyphenylene sulfide and the copolymer have a weight ratio of 98:2 to 92:8, wherein the copolymer includes: a repeating unit corresponding to polyether sulfone and a repeating unit corresponding to vinyl monomer, wherein the repeating unit corresponding to polyether sulfone has a repeating number of 200 to 450, and the repeating unit corresponding to vinyl monomer has a repeating number of 20 to 100.

In some embodiments, the vinyl monomer is

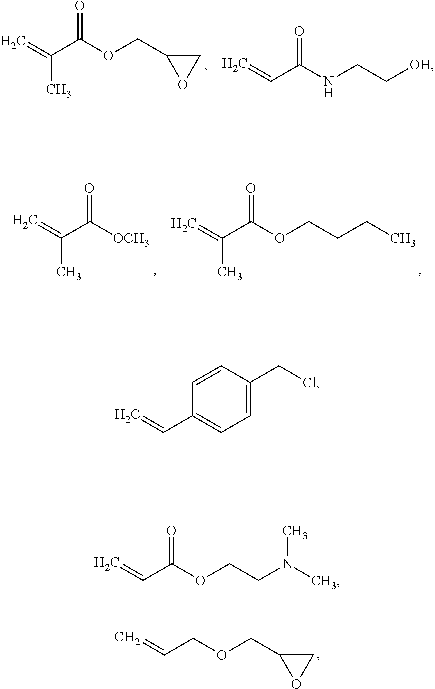

or a combination thereof.

In some embodiments, the repeating unit corresponding to polyether sulfone is

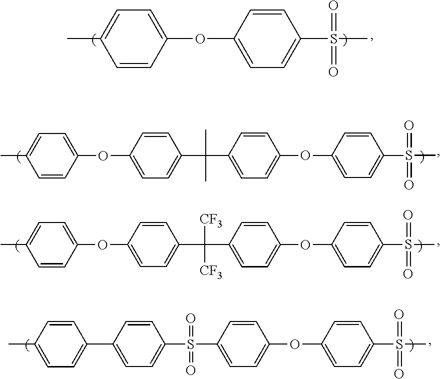

or a combination thereof.

In some embodiments, the polyphenylene sulfide has a repeating unit of

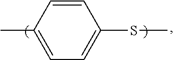

and the polyphenylene sulfide has a melt index of 100 g/10 min to 200 g/10 min.

A detailed description is given in the following embodiments with reference to the accompanying drawings.

### BRIEF DESCRIPTION OF THE DRAWINGS

The disclosure can be more fully understood by reading the subsequent detailed description and examples with references made to the accompanying drawings, wherein:

FIGURE shows a comparison of rheology analysis between polyphenylene sulfide (PPS) and a blend of polyphenylene sulfide and a copolymer of polyether sulfone and glycidyl methacrylate (PPS+PES-GMA).

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

One embodiment of the disclosure provides a method of forming a copolymer, including exposing a solution of polyether sulfone by ultraviolet radiation to form polyether sulfone radical. In some embodiment, the solvent for dissolving the polyether sulfone can be N-methylpyrrolidone, dimethylformamide, dimethyl acetamide, dimethylsulfoxide, or a combination thereof, and the concentration of the polyether sulfone in the solution can be 5 wt % to 30 wt %. If the polyether sulfone concentration is too low, the yield will be too low. If the polyether sulfone concentration is too high, it will not be completely dissolved.

The polyether sulfone radical can be copolymerized with the vinyl monomer to form a copolymer, so that the copolymer includes a repeating unit corresponding to polyether sulfone and a repeating unit corresponding to vinyl monomer. In some embodiments, the vinyl monomer can be dissolved in the solution of the polyether sulfone before the solution is exposed to ultraviolet radiation. Alternatively, the solution of the polyether sulfone is first exposed to the ultraviolet radiation, and the vinyl monomer is then added to the solution containing the polyether sulfone radical. In the copolymer, the repeating unit corresponding to polyether sulfone has a repeating number of 200 to 450, and the repeating unit corresponding to vinyl monomer has a repeating number of 20 to 100. If the repeating number of the repeating unit corresponding to polyether sulfone is too low, the thermal resistance of the copolymer will be lowered. If the repeating number of the repeating unit corresponding to vinyl monomer is too low, the properties of the copolymer cannot be efficiently modified. If the repeating number of the repeating unit corresponding to vinyl monomer is too high, the solubility of the copolymer will not be good.

In some embodiments, the vinyl monomer is

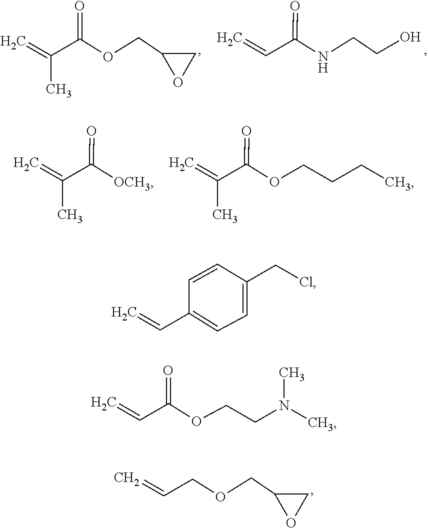

or a combination thereof. In some embodiments, the repeating unit corresponding to polyether sulfone is

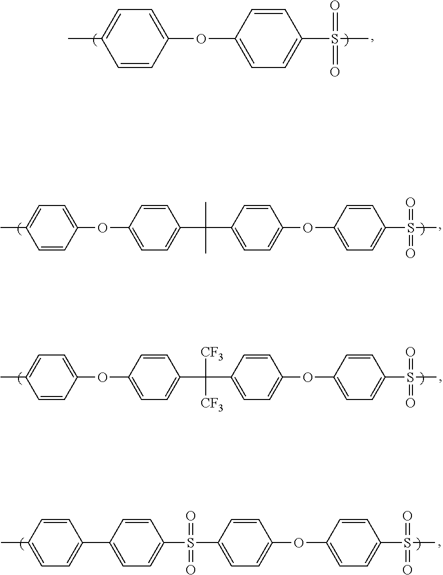

or a combination thereof.

The copolymer can be blended with another polymer. For example, the copolymer and polyphenylene sulfide can be mixed together to form a blend, in which the polyphenylene sulfide and the copolymer may have a weight ratio of 98:2 to 92:8. If the copolymer ratio is too low, the property improvement will be limited. If the copolymer ratio is too high, the compatibility will be lowered. In some embodiments, the polyphenylene sulfide has a repeating unit of

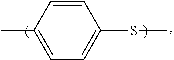

and the polyphenylene sulfide has a melt index of 100 g/10 min to 200 g/10 min (measured according to the standard ISO1133). If the melt index of the polyphenylene sulfide is too low, the blend cannot be molded. If the melt index of the polyphenylene sulfide is too high, the processability of the blend will be poor.

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

### EXAMPLES

### Example 1 (PES-GMA Copolymer)

Polyether sulfone (PES, Ultrason® E6020P, 10 g) and glycidyl methacrylate (GMA, 20 g) were added to N-methylpyrrolidone (NMP, 100 mL) and stirred to be evenly dissolved. The solution was exposed to ultraviolet radiation, and stirred and reacted at room temperature for several hours. The solution was poured into water to precipitate white solid. The white solid was washed with ethanol to remove residual solvent and monomer. The washed solid was dried at 80° C. to obtain a copolymer PES-GMA. According to NMR spectrum (Bruker 400 MHz, DMSO-d₆) of the copolymer PES-GMA, a repeating unit corresponding to GMA had a repeating number of 96, and a repeating unit corresponding to PES had a repeating number of 288, and PES/GMA ratio was 75:25. GMA has a chemical structure of

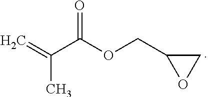

97 parts by weight of polyphenylene sulfide (PPS, 3220 commercially available from Zhejiang Xinhecheng Company Limited, melt index of 160 g/10 min, measured according to the standard ISO1133) and 3 parts by weight of PES-GMA were introduced into a twin-screw extruder to be blended at 310° C. to form a blend. PPS and the blend were put into a differential scanning calorimeter (DSC, TA-100), respectively, then heated from room temperature to 310° C. at a heating rate of 10° C./min, kept at 310° C. for 2 minutes, and then cooled from 310 to room temperature by a cooling rate of 40° C./min to measure the melting point, crystallization point, and crystallinity of PPS and of the blend, which are tabulated in Table 1. The crystallization point of PPS was lowered from 236° C. to 227° C. after being blended with PES-GMA. In the thermoplastic polymer process, the temperature range between the melting point and the crystallization point is defined as a processable window. A higher processable window means a higher processability of the thermoplastic polymer, which is beneficial to process a fiber and a film of the thermoplastic polymer.

TABLE 1

| | Melting | Crystallization | Crystallinity |
|---|---|---|---|
| | point (° C.) | point (° C.) | (%) |
| PPS | 279 | 236 | 43 |
| PPS + PES-GMA | 281 | 227 | 54 |

30 g of PPS and 30 g of the blend (PPS+PES-GMA) were filled in rheometer sample tubes and compacted, respectively, and then extruded at 310° C. to record their viscosities in different shear rates. The blend had a viscosity similar to that of the original PPS, and it is reasonable to estimate that these two have similar melting flowability, as shown in FIGURE.

The physical properties of PPS and the blend (PPS+PES-GMA) were measured, respectively, as tabulated in Table 2. The tensile strength and strain were measured according to the standard ASTM-D638, and the impact strength was measured according to the standard ASTM-D256.

TABLE 2

| | | | Impact | Impact |
|---|---|---|---|---|
| | Tensile | | strength | strength |
| | strength | Strain | (Notched) | (Unnotched) |
| | (Kgf/cm²) | (%) | (ft-lb/in) | (ft-lb/in) |
| PPS | 886 | 8.8 | 0.55 | 9.9 |
| PPS + PES-GMA | 884 | 3.1 | 0.59 | 14.1 |

### Example 2 (PES-GMA Copolymer)

PES (Ultrason® E6020P, 10 g) and GMA (25 g) were added to NMP (100 mL) and stirred to be evenly dissolved. The solution was exposed to ultraviolet radiation, and stirred and reacted at room temperature for several hours. The solution was poured into water to precipitate white solid. The white solid was washed with ethanol to remove residual solvent and monomer. The washed solid was dried at 80° C. to obtain a copolymer PES-GMA. According to NMR spectrum (Bruker 400 MHz, DMSO-d₆) of the copolymer PES-GMA, a repeating unit corresponding to GMA had a repeating number of 99, and a repeating unit corresponding to PES had a repeating number of 242, and PES/GMA ratio was 71:29.

97 parts by weight of PPS (3220 commercially available from Zhejiang Xinhecheng Company Limited, melt index of 160 g/10 min, measured according to the standard ISO1133) and 3 parts by weight of PES-GMA were introduced into a twin-screw extruder to be blended at 310° C. to form a blend.

### Example 3 (PES-GMA Copolymer)

PES (Ultrason® E6020P, 30 g) and GMA (50 g) were added to NMP (100 mL) and stirred to be evenly dissolved. The solution was exposed to ultraviolet radiation, and stirred and reacted at room temperature for several hours. The solution was poured into water to precipitate white solid. The white solid was washed with ethanol to remove residual solvent and monomer. The washed solid was dried at 80° C. to obtain a copolymer PES-GMA. According to NMR spectrum (Bruker 400 MHz, DMSO-d₆) of the copolymer PES-GMA, a repeating unit corresponding to GMA had a repeating number of 64, and a repeating unit corresponding to PES had a repeating number of 396, and PES/GMA ratio was 86:14.

93 parts by weight of PPS (3220 commercially available from Zhejiang Xinhecheng Company Limited, melt index of 160 g/10 min, measured according to the standard ISO1133) and 7 parts by weight of PES-GMA were introduced into a twin-screw extruder to be blended at 310° C. to form a blend.

### Example 4 (PES-HEAA Copolymer)

PES (Ultrason® E6020P, 30 g) and N-(hydroxyethyl)acrylamide (HEAA, 13 g) were added to NMP (100 mL) and stirred to be evenly dissolved. The solution was exposed to ultraviolet radiation, and stirred and reacted at room temperature for several hours. The solution was poured into water to precipitate white solid. The white solid was washed with ethanol to remove residual solvent and monomer. The washed solid was dried at 80° C. to obtain a copolymer PES-HEAA. According to NMR spectrum (Bruker 400 MHz, DMSO-d₆) of the copolymer PES-HEAA, a repeating unit corresponding to HEAA had a repeating number of 26, and a repeating unit corresponding to PES had a repeating number of 298, and PES/HEAA ratio was 92:8. HEAA has a chemical structure of

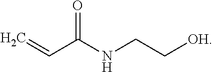

97 parts by weight of PPS (3220 commercially available from Zhejiang Xinhecheng Company Limited, melt index of 160 g/10 min, measured according to the standard ISO1133) and 3 parts by weight of PES-HEAA were introduced into a twin-screw extruder to be blended at 310° C. to form a blend.

### Example 5 (PES-MMA Copolymer)

PES (Ultrason® E6020P, 15 g) and methyl methacrylate (MMA, 16 g) were added to NMP (150 mL) and stirred to be evenly dissolved. The solution was exposed to ultraviolet radiation, and stirred and reacted at room temperature for several hours. The solution was poured into water to precipitate white solid. The white solid was washed with ethanol to remove residual solvent and monomer. The washed solid was dried at 80° C. to obtain a copolymer PES-MMA. According to NMR spectrum (Bruker 400 MHz, DMSO-d₆) of the copolymer PES-MMA, a repeating unit corresponding to MMA had a repeating number of 29, and a repeating unit corresponding to PES had a repeating number of 388, and PES/MMA ratio was 93:7. MMA has a chemical structure of

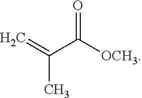

97 parts by weight of PPS (3220 commercially available from Zhejiang Xinhecheng Company Limited, melt index of 160 g/10 min, measured according to the standard ISO1133) and 3 parts by weight of PES-MMA were introduced into a twin-screw extruder to be blended at 310° C. to form a blend.

### Example 6 (PES-BMA Copolymer)

PES (Ultrason® E6020P, 15 g) and butyl methacrylate (BMA, 23 g) were added to NMP (150 mL) and stirred to be evenly dissolved. The solution was exposed to ultraviolet radiation, and stirred and reacted at room temperature for several hours. The solution was poured into water to precipitate white solid. The white solid was washed with ethanol to remove residual solvent and monomer. The washed solid was dried at 80° C. to obtain a copolymer PES-BMA. According to NMR spectrum (Bruker 400 MHz, DMSO-d₆) of the copolymer PES-BMA, a repeating unit corresponding to BMA had a repeating number of 21, and a repeating unit corresponding to PES had a repeating number of 391, and PES/BMA ratio was 95:5. BMA has a chemical structure of

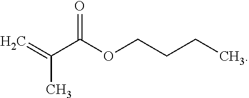

97 parts by weight of PPS (3220 commercially available from Zhejiang Xinhecheng Company Limited, melt index of 160 g/10 min, measured according to the standard ISO1133) and 3 parts by weight of PES-BMA were introduced into a twin-screw extruder to be blended at 310° C. to form a blend.

### Example 7 (PES-VBC Copolymer)

PES (Ultrason® E6020P, 15 g) and 4-vinylbenzyl chloride (VBC, 24 g) were added to NMP (150 mL) and stirred to be evenly dissolved. The solution was exposed to ultraviolet radiation, and stirred and reacted at room temperature for several hours. The solution was poured into water to precipitate white solid. The white solid was washed with ethanol to remove residual solvent and monomer. The washed solid was dried at 80° C. to obtain a copolymer PES-VBC. According to NMR spectrum (Bruker 400 MHz, DMSO-d₆) of the copolymer PES-VBC, a repeating unit corresponding to VBC had a repeating number of 21, and a repeating unit corresponding to PES had a repeating number of 397, and PES/VBC ratio was 95:5. VBC has a chemical structure of

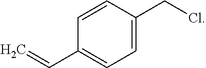

97 parts by weight of PPS (3220 commercially available from Zhejiang Xinhecheng Company Limited, melt index of 160 g/10 min, measured according to the standard ISO1133) and 3 parts by weight of PES-VBC were introduced into a twin-screw extruder to be blended at 310° C. to form a blend.

### Example 8 (PES-DAEA Copolymer)

PES (Ultrason® E6020P, 15 g) and 2-(dimethyl amino)ethyl acrylate (DAEA, 25 g) were added to NMP (150 mL) and stirred to be evenly dissolved. The solution was exposed to ultraviolet radiation, and stirred and reacted at room temperature for several hours. The solution was poured into water to precipitate white solid. The white solid was washed with ethanol to remove residual solvent and monomer. The washed solid was dried at 80° C. to obtain a copolymer PES-DAEA. According to NMR spectrum (Bruker 400 MHz, DMSO-d₆) of the copolymer PES-DAEA, a repeating unit corresponding to DAEA had a repeating number of 73, and a repeating unit corresponding to PES had a repeating number of 384, and PES/DAEA ratio was 84:16. DAEA has a chemical structure of

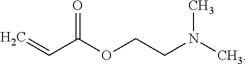

97 parts by weight of PPS (3220 commercially available from Zhejiang Xinhecheng Company Limited, melt index of 160 g/10 min, measured according to the standard ISO1133) and 3 parts by weight of PES-DAEA were introduced into a twin-screw extruder to be blended at 310° C. to form a blend.

### Example 9 (PES-AGE Copolymer)

PES (Ultrason® E6020P, 15 g) and allyl glycidyl ether (AGE, 24 g) were added to NMP (150 mL) and stirred to be evenly dissolved. The solution was exposed to ultraviolet radiation, and stirred and reacted at room temperature for several hours. The solution was poured into water to precipitate white solid. The white solid was washed with ethanol to remove residual solvent and monomer. The washed solid was dried at 80° C. to obtain a copolymer PES-AGE. According to NMR spectrum (Bruker 400 MHz, DMSO-d₆) of the copolymer PES-AGE, a repeating unit corresponding to AGE had a repeating number of 25, and a repeating unit corresponding to PES had a repeating number of 393, and PES/AGE ratio was 94:6. AGE has a chemical structure of

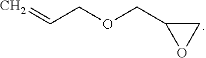

97 parts by weight of PPS (3220 commercially available from Zhejiang Xinhecheng Company Limited, melt index of 160 g/10 min, measured according to the standard ISO1133) and 3 parts by weight of PES-AGE were introduced into a twin-screw extruder to be blended at 310° C. to form a blend.

It will be apparent to those skilled in the art that various modifications and variations can be made to the disclosed methods and materials. It is intended that the specification and examples be considered as exemplary only, with the true scope of the disclosure being indicated by the following claims and their equivalents.

What is claimed is:

1. A copolymer, comprising:
a repeating unit corresponding to polyether sulfone and a repeating unit corresponding to vinyl monomer,
wherein the repeating unit corresponding to polyether sulfone has a repeating number of 200 to 450, and the repeating unit corresponding to vinyl monomer has a repeating number of 20 to 100.

2. The copolymer as claimed in claim 1, wherein the vinyl monomer is 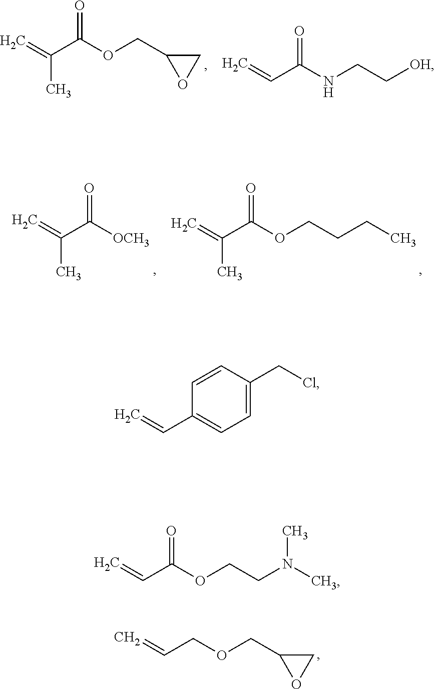
or a combination thereof.

3. The copolymer as claimed in claim 1, wherein the repeating unit corresponding to polyether sulfone is 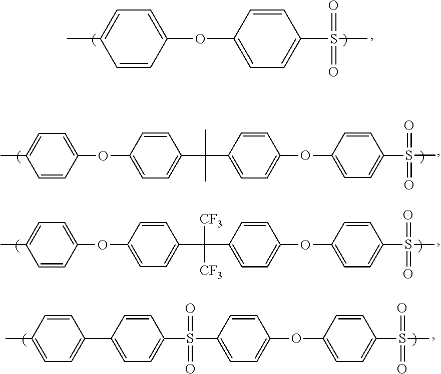
or a combination thereof.

4. A blend, comprising:
polyphenylene sulfide and a copolymer blended to each other, wherein the polyphenylene sulfide and the copolymer have a weight ratio of 98:2 to 92:8,
wherein the copolymer includes:
a repeating unit corresponding to polyether sulfone and a repeating unit corresponding to vinyl monomer,
wherein the repeating unit corresponding to polyether sulfone has a repeating number of 200 to 450, and the repeating unit corresponding to vinyl monomer has a repeating number of 20 to 100.

5. The blend as claimed in claim 4, wherein the vinyl monomer is 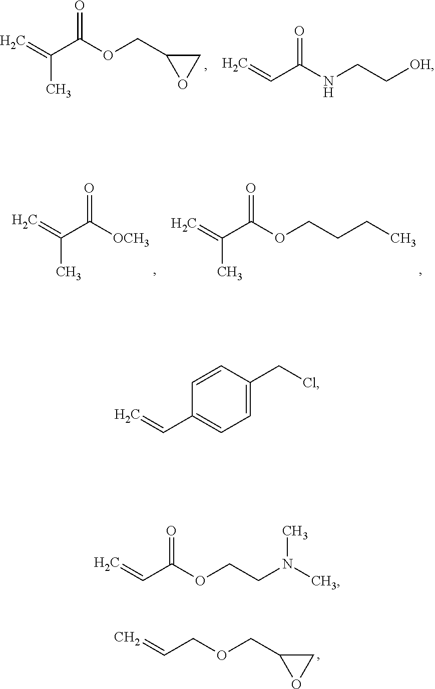
or a combination thereof.

6. The blend as claimed in claim 4, wherein the repeating unit corresponding to polyether sulfone is 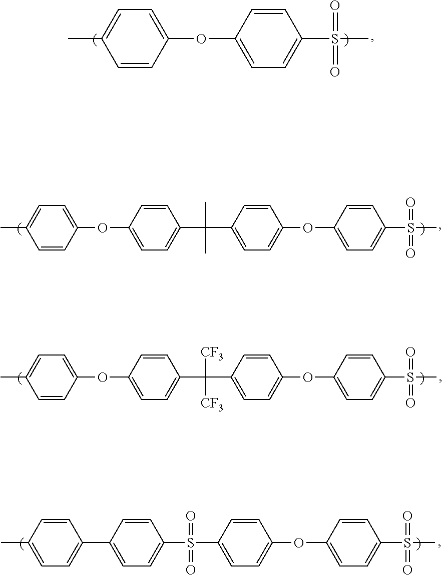
or a combination thereof.

7. The blend as claimed in claim 4, wherein the polyphenylene sulfide has a repeating unit of 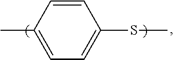
and the polyphenylene sulfide has a melt index of 100 g/10 min to 200 g/10 min.
